(19) United States
(12) Patent Application Publication
(10) Pub. No.: US 2003/0037263 A1
(43) Pub. Date: Feb. 20, 2003

(54) Dynamic rules-based secure data access system for business computer platforms

(75) Inventors: Nishad Kamat, Bangalore (IN); Svn Vishwanathan, Bangalore (IN); Bangalore S. Prabhakar, Bangalore (IN); Tarak Goradia, Bangalore (IN); Amitabh Saran, Bangalore (IN)

Correspondence Address: STOEL RIVES LLP, 900 SW FIFTH AVENUE, SUITE 2600, PORTLAND, OR, 97204, US

(73) Assignee: TriVium Systems Inc., Hillsboro, OR (US)

(21) Appl. No.: 10/215,882

(22) Filed: Aug. 8, 2002

Related U.S. Application Data
(60) Provisional application No. 60/311,020, filed on Aug. 8, 2001.

(51) Int. Cl. H04L 9/00

(52) U.S. Cl. 713/202

(57) ABSTRACT

The invention provides a dynamic rules-based secure data access system that may be used in a variety of applications that include a requirement for controlled secure access to a database. The rules-based access system has several features. One of these is that each user be assigned a role, either as an individual or as part of the group. Access rights may be assigned based on roles, but these can be modified within the system by individual users, that have authority to do so. Further, the data resources that each user is allowed to access, based on his or her role, and the extent of viewing and of data manipulation allowed, is further controlled based on assigned “rights and privileges”.

Another feature is that the database may be viewed as structured and organized into “business functions”, which are useful in business enterprises, such as sales, marketing, customer supports, etc. Users may be restricted to only certain functions, based on their roles. Within the business function units, the resources may be regarded as are further subdivided into several hierarchy levels; such as business objects, and instances of these objects. Users may be allowed access to only a specific business function, and only specific levels within that functional unit, based on role. Further, data may be restricted within each of the hierarchy levels, so that a user with access may not be allowed to see or manipulate all resources on a particular level within the hierarchy.

### RELATED APPLICATIONS

This application claims priority from U.S. Provisional Patent Application Serial No. 60/311,020, filed Aug. 8, 2001.

### TECHNICAL FIELD

The invention is in the field of software, and more particularly relates to a dynamic rules-based system for controlling access to resources of databases of all kinds, in particular databases associated with computer business platforms, but other databases as well.

### BACKGROUND OF THE INVENTION

With the now almost universal use of computers and telecommunications in business operations, and with the increasing amount of information that must be stored, businesses and other organizations have developed increasingly large and complex databases. These databases are valuable corporation and organizational resources, and in many instances the resources or data contained are of a sensitive nature, either because they relate to sensitive business plans, private information about individuals, or information that may be privileged under law (for example, patient records in a hospital). Further, the use of global computer networks, linked together through the internet, has significantly increased the risk that outsiders may trespass to these databases, and access sensitive information. Indeed, an entire industry has developed around the securing of the networks of an organization from access by outside third parties, through the development of firewalls and other devices. However, aside from the threat of outside trespass to a database, there also exists a need within most organizations for the selective exclusion of certain parties from access to certain information, and the reservation of access to this information to only certain designated individuals or groups.

There are a number of systems that are designed to control access to databases, by authenticated users. These systems are often based on roles that are assigned to individuals, and that are “fixed” in the sense that an individual may be assigned only one role and each role carries with it certain access limitations. These static rules-based secure access systems generally do not assign individuals to group roles, that are different from their assigned roles, and do not permit further fine tuning of roles assigned to individual users. Further, although a database may be hierarchical, static data access systems generally only screen to see whether a user is allowed access to a particular level of the hierarchy or not. If the user is allowed access, the user can generally access all information or resources on that level, and there is usually no provision to screen the user from certain information on that level that desirably should be restricted. Thus, the static rules-based secure data access systems lack certain features that may be desirable in an organizational context, whether a business organization, governmental organization, or other entity that has information in a database to which access must desirably be restricted in a more flexible manner, for example, to allow limited view only access, or to allow limited data manipulation, and the like.

### SUMMARY OF THE INVENTION

The invention provides a dynamic rules-based secure data access system, that may be used in a variety of applications that include a requirement for controlled access to a database. In particular, the secure data access system may be used in connection with customer (or other) business relationship platforms, but is not limited to such use and may be used with databases generally.

In one aspect, the secure data access system controls access to a database that contains resources. These resources may, as an initial matter, be organized into functions, such as sales, marketing, customer relations, and the like, in the case of a business. In accordance with the invention, access to resources of these business functions in the database can be controlled. Further, the resources within each business function may then be organized into a hierarchical arrangement, having at least four levels, to which access can be controlled. In one aspect of the invention, at least one “role” is assigned to each accessor, and the role determines the level of the hierarchical arrangement at which the accessor is allowed to access resources, and in certain instances, particular resources that the accessor may access, despite other restrictions on his assigned role or roles. Further, the invention defines “rights and privileges” that are associated with each accessor, to allow the accessor to either view part of the resource, view all of the resource, or to carry out a variety of manipulations on the resource, including such activities as writing, deleting, modifying, and the like.

In one aspect of the invention, the dynamic rules-based secure data access system is in communication with a database, and with a scalable messaging platform. In other aspects, the database may be in such communication with a messaging platform. However, communication with the messaging platform provides numerous advantages, in certain situations, such as in customer relation management applications.

In a further aspect of the invention, the invention provides a system comprising a secure database access protocol, for controlling access to a database that has information organized in a hierarchy. The access protocol has decision criteria for controlling access to the database, and the criteria utilizes roles assigned to the potential accessors of the database to control access to any one or more levels of the hierarchy. Further, the system includes rules defining rights and privileges of those persons who are accessors of one or more levels of the hierarchy.

In another aspect of the invention, there is provided a secure data access system for controlling access to a database, that includes information or resources accessible in a hierarchical arrangement. The system includes identifying a user seeking access to the database as an accessor, and determining the role of the accessor. Based on a determination of the role of the accessor, the system then determines the level of the hierarchy of information to which the accessor will have access, as well as what information within that level the accessor has the right to access. Further, the system identifies the rights and privileges of the accessor, with respect to the information that the accessor is allowed to access.

The foregoing summary presents only certain aspects of the invention, and is a nonlimiting description. The scope of the invention may only be determined by the claims, here below. Additional aspects and advantages of this invention will be apparent from the following detailed description of preferred embodiments thereof, which proceeds with reference to the accompanying drawings.

### BRIEF DESCRIPTION OF THE DRAWINGS

FIG. 1 is a diagram of an embodiment of a Customer Relations Management System software, that may be used in conjunction with the secure data access system in accordance with the invention;

FIG. 2 is a screen of a terminal display, illustrating an embodiment of the invention, depicting the “rights and privileges” of an individual accessor to the business function level of the hierarchy;

FIG. 3 is a terminal display screen, depicting an embodiment of the invention, showing the “user defaults” for the “rights and privileges” of a particular user;

FIG. 4 is a screen of a terminal, depicting an embodiment of the invention, displaying the rights and privileges given to everyone within a system;

FIG. 5 is a display screen of a terminal, illustrating an embodiment of the invention, and depicting the privileges defined for various roles within a system;

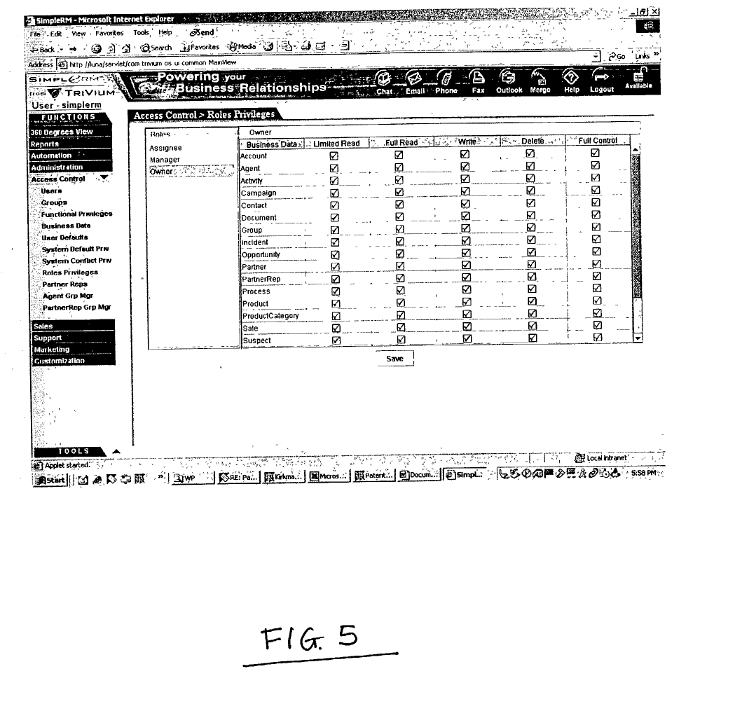

FIG. 6 is a logic flow diagram depicting the gate checks in a representative embodiment of the secure data access system of the invention;

FIG. 7 is an example of a logic diagram illustrating a representative “arbiter” function of the secure data access system of an embodiment of the invention, and

FIG. 8 is a block diagram illustrating an embodiment of the data access system, in accordance with the invention.

### DETAILED DESCRIPTION OF PREFERRED EMBODIMENT

The invention provides a dynamic rules-based secure data access model for accessing databases. While the invention has general applicability, it is particularly useful in a business context, and more particularly useful in the context of relationship platforms, such as customer relationship management (CRM) platform.

The invention is useful with systems that have only one database, but can also be used with systems that have multiple databases. The invention uses rules to determine which resources of the database the user may access, which the user may view, and which resources the user may manipulate. In order to make this determination, the user is assigned at least one “role”, which determines, with few exceptions, the user's rights and privileges with regard to resource access and restrictions on resource viewing and manipulation once accessed. Thus, roles and rights and privileges determine to a large extent the user's capability to meet the security system's criteria for accessing resources in the database.

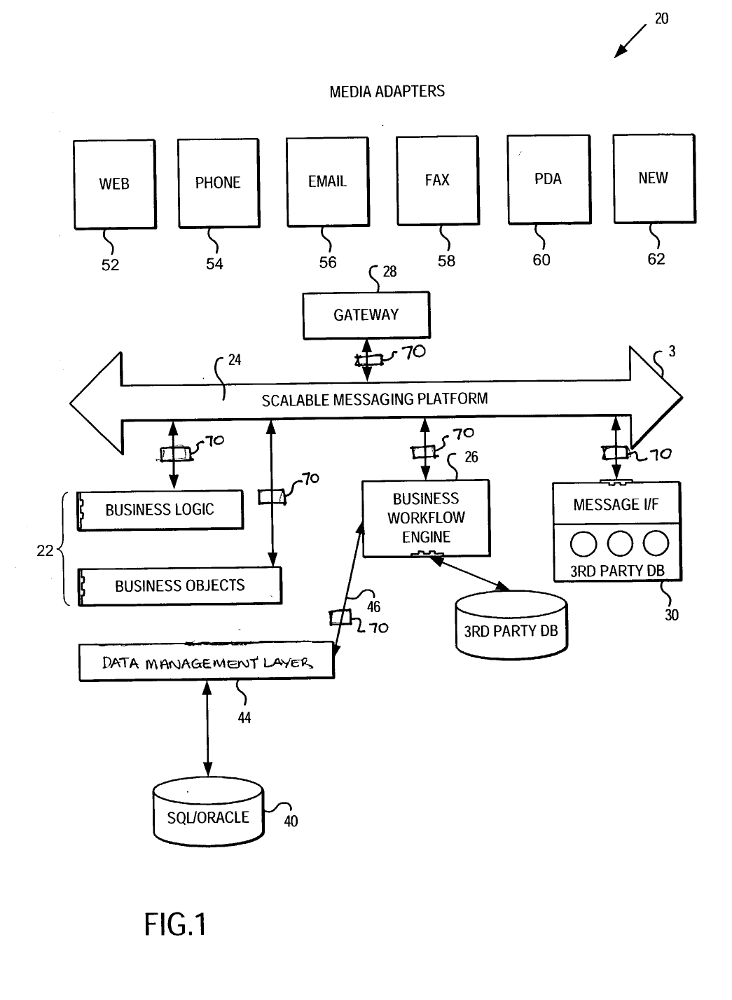

By way of background, and to simplify explanation of the invention, reference will be made to a scalable customer relation management system, shown in FIG. 1. Certain aspects of this system are described and claimed in our co-pending patent applications entitled “Workflow Engine for a Scalable Multiprocessor Relational Platform Architecture”, U.S. Ser. No. ______ and “Scalable Multiprocessor Architecture for Business Computer Platforms”, U.S. Ser. No. ______ , filed concurrently herewith. As shown, users may access the system through the web, telephone, e-mail, fax, wireless personal digital assistant (PDA), and provision is made for access through new (and perhaps as yet unknown) methodologies 10. These users access the system through a gateway 12 that communicates with a messaging bus 14. The messaging bus 14, is in turn in communication with a database 16, that includes the layers shown: namely business logic 18, business objects 20, a data manager layer 22, and an SQL/Oracle or other type of database 24. Further, as shown in FIG. 1, the messaging bus is also in communication with a business workflow engine 26, and other third party applications 28. Security, which is discussed in more detail herebelow, is administered at various points 70 of the platform and is designed to check all incoming and outgoing message exchanges.

The messaging bus 14 or platform utilizes two primary forms of communication, using messages that are formatted to have a header and a payload. The header specifies source, destination, time and type of message; while the payload is only understood at the source and destination and has, for example, “name:value” fields, for example a stock market symbol and price. The messaging bus 14 communicates through request-reply transactions, in which for instance a user application requests configuration data from a server database application; and it also communicates through publish-subscribe events, in which events can be published using the client adapter interface to carry messages to user applications subscribing to those events. In addition, monitoring applications (tracing, statistics, utilization monitors, and the like) can also subscribe to this information. In short, the message bus 14 is able to carry out both forms of communication effectively.

FIG. 1 is a simplified architecture diagram showing the principal components and interfaces of a scalable platform 20. In particular, FIG. 1 illustrates the conceptual layering and the communications employed. From a high level perspective, the major subsystems are Business Logic and Business Objects 22; Messaging Platform 24; Business Workflow Framework 26; Communications Gateway 28; and Application Integration Framework 30. These elements, each of which is discussed herebelow, together form an extensible platform that is easily customized for many different industries and applications; it can be used in almost any commercial business enterprise, as further explained later. All the access points are monitored through the strict security system of the invention that is described below.

The Business Logic and Business Objects 22 provide the means for managing and interacting with stored data. Preferably, a standard, commercially available database system, for example an SQL system from Oracle, 40 in FIG. 1, is implemented. The database 40 stores tables of data, as is conventional in a relational database, including data objects. These are accessed using standard queries by the Data Manager 44. The Data Manager decouples the rest of the system from the underlying database technology so that any appropriate database system can be used, and upgraded if necessary without changing the platform.

The Data Manager 44 translates business operations into the query language of the underlying database, so that business workflow operations (further discussed later) are database independent. The Data Manager also manages database connection pooling, so that a limited number of connections can be used while executing queries from multiple processes as needed. This helps to contain database licensing costs. In general, the Data Manager provides database access to the Business Workflow Engine 26 as indicated by interface arrow 46.

The Business Objects and Logic subsystem offers a consistent view of platform data and allows clients to perform high-level operations on these data. By “consistent view” we mean essentially that all of the various communication channels, workflow processes and applications utilize (and update) the same data, so it is necessarily consistent. For example, a given product description will be the same, whether accessed by a customer via fax or on the web.

High-level operations are enabled so that business logic and business objects “fit” the industry or application in which the platform is deployed. In a medical clinic application, for example, “customers” become “patients” and “products” may be medical procedures. Toward that end, “business objects” are software objects, including defined views, that are appropriate to the field of the application. The range of applications is virtually unlimited—examples include medical, education, real estate, automotive manufacturing, environmental cleanup, legal just to name a few. Thus a legal business object may be a will, or a litigation, or a court decision or a patent. An environmental business object may be a Superfund site, or a chemical, or an Environmental Impact Statement, etc.

Business Logic is again somewhat “vertical,” i.e., directed to specific industries or applications. Business logic imposes qualifications, constraints or operations on business objects, which can be thought of as rules, appropriate to the application.

The Business Objects and Logic subsystem also addresses system-wide common functions such as security, which is discussed in more detail below, and which is integral to the platform. However the dynamic secure data access system of the invention is not restricted to use only with business platforms, but is adaptable for use with any database, as explained below. The Business Objects and Logic subsystem also addresses licensing, database access (which is through the security system as a layer), and resource optimization. This functionality is exposed via the platform business API. In a presently preferred embodiment it comprises a Java® API and comes with XML “helpers” that provide efficient conversion between XML and Java objects. It also supports extensibility mechanisms for modifying or adding business rules, adding new business objects, and configuring for organization-specific databases and servers.

In the preferred embodiment, platform information is formally described in a published data model, and implemented in a commercial relational database. Access to the data is accomplished through well-defined transactions and queries implemented in a multi-tier architecture to ensure scalability and performance. Tables and their interdependencies are mapped onto Business Objects (BO) as noted above. A predefined though API extensible Business Logic is used to provide interactions across BOs. Further queries can also be written to support arbitrarily complex logic for a business.

The Data Manager (DM) component 44 can be used to invoke any object or query. DM basically contains classes that act as an interface to the applications and the database. The classes get the requests from other components or applications and service them efficiently, so that the latter need not have to deal with the database specific details. To provide efficiency and maximal reuse of resources, the DM pools database connections across users. Configuration parameters are provided for setting the maximum number of connections to be opened. Methods are provided to validate the connections and clean up any expired connections from the pool.

Applications require well-defined means of obtaining business data either solitarily (retail mode) or in bulk. SRP provides the following techniques to make this possible. These are collectively called object-querying methods as each mechanism returns complete business data objects (on success) or none at all (if the query failed).

Object naming: This is a retail-mode mechanism where an application can get a business data object from its persistent storage if it can provide a name for that object. The name is also known as the URL. Typically an application creates a business object, asks the API layer to store that object, and then gets the URL of that object. If it remembers the name, SRP can help the application reconstruct the object back from storage. Internally, the URL of an Object will carry sufficient information to identify the object, such as the type of Object, its relationship with the Database (persistent storage).

Simple Query Building: This is a bulk-mode mechanism that allows an application to simultaneously obtain more than one object. This is a primitive OQL-like query (except that there is no language). A simple object query in this manner can specify join relationships between multiple objects, Boolean logical conditions and even supports nesting queries within other queries. The result of executing the query is formulated as a collection of ordered collections. In addition to the objects themselves, it contains control (meta) information about the objects themselves.

Steps involved in using this mechanism are:

1. Create or acquire the objects implementing a simple query.

2. Supply the objects that are to be queried along with relationship among them

3. (Optional) If using a nested query, supply the Object attribute info.

4. Supply the Criteria if any, for attribute of Object participating in the query

5. Execute Query to get the Collection of objects

Pre-defined Query: This is a bulk-mode mechanism used when it is not possible to use the Simple Query builder. The Query is pre-built to retrieve a set of business Objects that have complex relationship amongst them or their selection criteria are quite complex. The result of executing this query is formulated as a collection of ordered collections. In addition to the objects themselves, it contains control (meta) information about the objects themselves.

Generic Query Object: This is a bulk-mode mechanism used if none of the previous techniques are suitable. This mechanism requires explicit knowledge of SQL and of the database. The result of executing this query is formulated as a collection of ordered collections. Unlike other query operations it returns only the individual attribute values (as in SQL). They bear no direct relationship with objects.

The platform described, once deployed, interacts with numerous users, clients, customers, etc., with minimal maintenance. For example, as explained later, it automatically “scales” to accommodate increases in user traffic or “events”. Nonetheless, some administration is necessary, especially prior to deployment and for subsequent “fine-tuning” or the introduction of new functionality. An administrative “console” (now shown) preferably includes on-screen interfaces or “screens” to (1) define business logic; (2) define business objects; and (3) define business workflows (see Workflow Editor below). These three activities, all somewhat interrelated, together define the application logic that transforms the generic platform into a specialized application specific platform.

The Business Workflow Framework offers a flexible, extensible, visual programming platform for automating routine customer interaction tasks and business processes within an organization. Easy-to-use editors enable the user to define workflows that get triggered in response to events in the systems. These events could be incoming interactions such as phone call, fax, emails, and web-form submissions or business events such as overdue tasks or imminent expiry of warranty periods or other organization-specific events. Wizards can be implemented to simplify tasks such as getting a web form to trigger a workflow. Workflows themselves are defined in terms of steps such as creating or modifying a business object, creating and sending an email or fax, making a decision based on a query, scheduling a timed event, and so on. It is also possible to create custom steps as well. A versatile business workflow engine is responsible for scheduling and executing the workflows. Its flexible design makes it possible to execute custom workflow steps in an isolated environment for better fail-safety.

Various communication channel adapters exchange messages with the workflow engine and other processing modules via a scalable messaging platform 24.

Referring to FIG. 1, it illustrates a Web adapter 52, a phone adapter 54, an e-mail adapter 56, a fax adapter 58 and a PDA adapter 60. New adapter 62 illustrates deploying an available adapter for any new communication medium.

The Messaging Platform subsystem 24 (“message bus”) is not literally a message highway or bus as illustrated conceptually. Rather, it comprises a collection of processes and objects forming part of the integrated data and event management scheme. In a presently preferred embodiment, the message platform is compliant with the Java Message Service (JMS) standard. We should introduce the notion of a client adapter an/or connector needed for all components that wish to connect to the platform.

The message bus utilizes two primary forms of communication:

1. Request-reply transactions—for instance, a user application needs to request configuration data from a server DB application.

2. Publish-subscribe events—events can be published using the client ID (This IS will start making sense when we discus the adapter above.) to carry messages to user applications subscribing to those events. In addition, monitoring applications (tracing, statistics, utilization monitors, etc.) can also subscribe to this information without any impact on network or server performance—the message is still only sent out on the message bus once.

All communication among internal components takes place on the Message Bus. Applications can utilize multiple ports to communicate between various modules in a point-to-point, as well as in a publish-subscribe (Write One Read All) fashion. The message bus will take care of:

Connection management and scalability

Message assembly and hiding the internal structure of a message

Marshalling/unmarshalling data within messages

Reliability

Message routing and subscription management

Subscribing and un-subscribing to messages is very fast, such that it is possible for applications to make and break subscriptions on a per-contact basis (if necessary) without causing undo overhead on critical server or network resources. Additional optimizations can be implemented for communications that occur on the same node through the use of shared memory.

In accordance with the present invention, there is provided a dynamic rules-based secure data access system that employs several strategies and that may be used with a relational platform, or with any other databases. These strategies include a hierarchical approach to organization of resources in a database; the use of “roles” that are applied to users (accessors) of the system, the use of automatic configurations to control access through roles; and the use of a query sub-system that permits the accessor to access only those resources that the user's role allows the user to “see” and to manipulate through “rights and privileges” that are granted to the accessor by the system (or by other ways). Each of these concepts will be explained below.

In a business context, it may be desirable for certain people to have access to only information pertaining to certain business functions. For example, it may be desirable to restrict access of the sales force to sales information, and not to provide accounting information to sales representatives. On the other hand, it may be desirable to allow marketing personnel (or only certain ones of such personnel) access to sales, accounting, and customer relations information. Each business organization will have specific requirements, and the invention has the flexibility to accommodate these varying requirements. In accordance with the invention, each user that is allowed to access the system is assigned a “role” which is a designation of that person as an individual based on that individual's business function, and the user may be assigned other roles, based on groups to which that user belongs in the organization. Thus, each user may have multiple roles. For example, John Smith may be assigned a role of salesman, and may also be part of a “group role”, the sales reps group. Thus he has access based on two roles. He might further be assigned a role as a customer support person, and so have access to resources available to customer support personnel.

As an initial matter, business functions within the organization may be identified. For example, sales, marketing and customer support. Once business functions have been identified, resources relating to these business functions resources may be organized, so that when a person who has been granted access rights (an “accessor”) to a particular business function, as explained below, accesses the resources of that business function via a terminal, the resources of that business functions are available to it on one or more screens. However, in most business organizations, it is not desirable for everyone to have access to all of the information relating to a particular business function. Hence, in accordance with the invention, each business function is further subdivided into “business objects”. These business objects are groupings of resources within the business functions, and relate to a collation of related business information. For example, while a business function is “Sales”, a business object may be “customers” in a certain geographic region, another business object may be a grouping of certain “products”; and another business object may be “sales opportunity”.

In addition, the resources may be further divided into “attributes”, and these attributes may be accessed by those that have been authorized by assigned role or otherwise. Thus, a business object may have a multiplicity of attributes, and rights to access these may be selectively allowed or denied to accessors based on their roles. Attributes can be base data types like integer or character string; or can be other business objects. For example, the “address” business objects comprises 6 attributes:

| Field | Type |
|---|---|
| Address Line 1 | Text |
| Address Line 2 | Text |
| City | Text |
| State | Text |
| Zip | Alphanumeric String (no spaces) |
| Country | Text |

And the “customer” business object could be defined as:

| Field | Type |
|---|---|
| Last Name | String |
| First Name | String |
| Address | Business Object |
| Phone | Text |

It is often desirable to further restrict the access of users of a system, so that even at the business object level, users may not access all the resources within each business object. For this reason, the invention provides a further level of data access control. Each business object is further organized into “instances”. Thus, for example, while the Sales function (as explained) may be divided into several business objects, the customer business object may in turn be further divided so that each customer is an instance (for example, Smith; John; {2332 Dearborn Avenue; Suite 200; Hillsboro; Oregon; 97124; USA}; (555)555-5555); and the products object may be further subdivided so that each product is an instance (for example, [TV], [DVD], [VCR]).

The above hierarchical system of setting up at least four layers (functions, business objects, attributes and instances) within each business function provides a basis for controlling access to resources of the business function (i) at the business function level, (ii) the business object level, and (iii) the instance level. Thus, for example, a sales manager may have access to the entire sales function, and would be able to see on his screen all resources relating to sales. A regional sales manager may have access to only sales within a geographic area that she controls, and her screen would only display the resources of that business object. In accordance with the invention, these screens may be configured so that information that the manager is not authorized to access, will not display as “blanks” or in any other way indicate that not all information is being displayed. In other words, as far as the regional manager with access to only her authorized business objects is concerned, she may be lead to believe from her screen that she is accessing all resources.

In a further example, the system permits rules-based controls such that a sales representative may have his or her access restricted to only certain customers that he or she is charged with servicing. Thus, the sales representative would not see the same screen as the sales manager, or the regional sales manager. Rather, his or her screen would be restricted to far less resources, although these resources may appear in the screens of the regional sales manager and the sales manager, albeit that this appearance may be in a summary form, or in a different format.

With regard to access control, the rules-based secure data access model of the invention is based around three independent concepts. These concepts are “accessors”, “resources”, and “rights and privileges”. The accessors are the users, groups of users, or roles performed by users. And, the users are generally those qualified to access a resource. For example, the roles may be defined in a business context as “owner”, “assignee”, “manager of owner”, “manager of assignee”, “analyst”, and “administrator”. The administrator may have overall privileges to manipulate all resources. Other designations may of course be used. Depending on the role assigned to an individual, that individual will have greater or less access, as further explained below.

In these specification and claims, the term “resource” refers to items or information of the database to which access can be regulated, either individually or collectively, from both the user and resource points of view. For example, as explained above, if the business functions are organized such that only sales personnel have access to the sales business function, then a person assigned the role of accounting manager may not be able to access the resources of the sales business function. Thus, he is restricted by the rules of accessing the business function, and the fact that by his assigned role he is not a member of the sales force. In the specification, the term “resources” therefore includes functional modules, the screens, forms and options, business objects, classes of business objects, and instances.

In the specification and claims, the term “database” encompasses any data repository, including without limitation, files, relational databases, secondary storage devices, and the like.

In the specification and claims, the term “rights and privileges” means the rights granted to an authenticated accessor of a resource. These rights and privileges provide fine-grained control, and include control over activities such as creating resources, reading resources, writing to resources, deleting resources, and the like. These rights and privileges can be set to allow access, deny access, or to leave open or “unspecified” access to a particular resource, so that a security subsystem, described below, will determine access.

In accordance with the invention, access can be controlled either on the basis of an individual role or a collective role to two types of business resources: functional modules, and business objects.

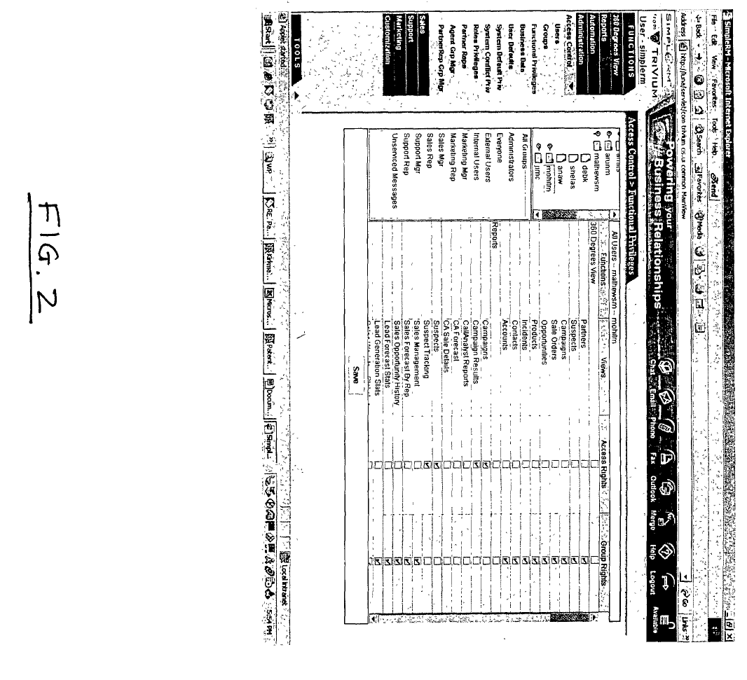

The functional modules are visible aspects of the scalable relationship platform, and include the viewable screens, forms and options presented therein. For example, as discussed before, the business function or functional module for Sales has all sales resources and is viewable on a screen. For example, FIG. 2 illustrates a display screen, in accordance with an embodiment of the invention, that shows the rights and privileges of an individual (‘mohitm’, in this example) to see a business function screen. The “group rights” column illustrates the rights given to the user, as a consequence of the user's membership in the group, which has a particular role. Thus, for example, if the user is a sales representative, then certain group rights may be given to him as a consequence of his membership in the group role that includes all of the sales representatives. The “access rights” column is available to be easily amended for new privileges to be granted specifically to the user, who is in this case designated “mohitm”. Note that, functional modules have an “elementary” access provision that is, they are either viewable or not viewable. In accordance with the invention, certain individuals may be granted functional module access, for example the marketing manager may have access to the marketing module.

The business object is a resource that contains all the information about the entity to which it relates. For example, the “customer” business object contains all of the resources regarding the entity “customer”. Business objects may be viewed partially, completely, or not at all depending upon rights and privileges granted by the system. Accordingly, they have a controlled and regulated range of flexibility for access. For example, while all regional sales managers may have the right to view all sales resources within their particular regions, they may not have the rights and privileges to delete or modify sales information of a particular customer, and those rights may instead be assigned to a sales representative. Likewise, while a regional sales manager may be granted, in accordance with the system of the invention, the right to view resources in sales regions other than his own, he may not have the right to make any modifications to the resources.

Further, in accordance with the invention, owners (a role) of individual business objects (generally the person(s) who created those objects), can further regulate access to these objects. For example, if a sales person creates a sales lead, he can make the sales lead available to his sales manager for viewing, but may not decide to make the sales lead available to his fellow sales representatives. In another example, the sales representative may make the sales lead available to his fellow sales representatives to view, but may elect to deny them access to certain specific information, such as the amount of sales that he is negotiating with that particular lead. In other words, the creator or owner of a business object can, in accordance with the invention, regulate the degree of access that he or she wishes to allow through his/her capability to personally restrict or allow access.

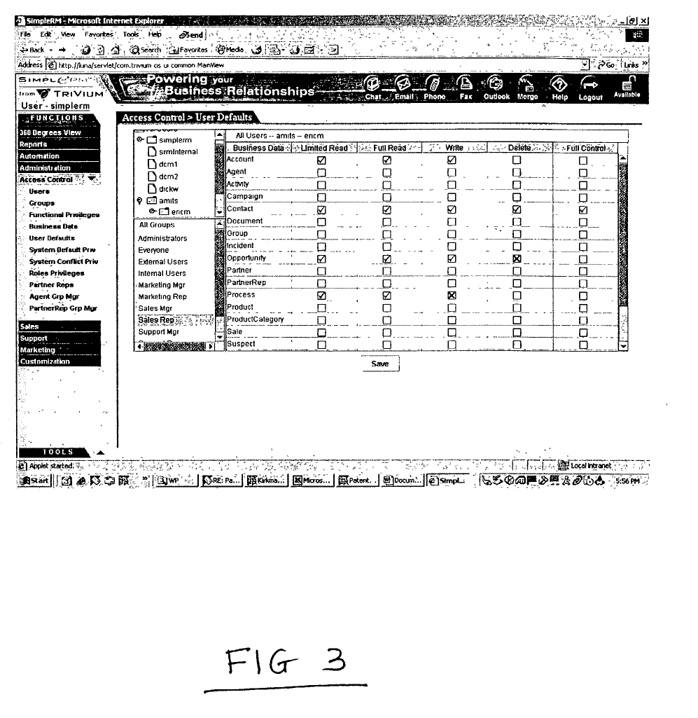

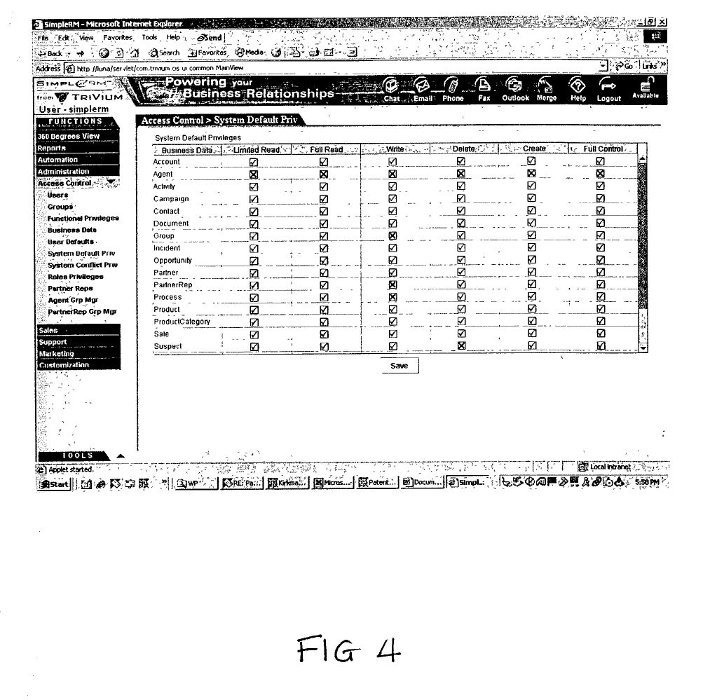

As indicated before, the regulation of access to accessors with roles is generally through “rights and privileges” that define the nature of restraints on the access. These rights and privileges may be described as follows: the right to create objects; the right to read the contents of a resource (a “full read” allows the accessor to view all the attributes of the resource while a “limited read” allows the accessor to view only a configured set of attributes of the resource); the right to write (which is a right to modify all contents of the resource); and the right to delete all contents of the resource. For example, FIG. 3 shows a display screen indicating the default privileges that may be granted to every user in a particular business organization, when they are designated as users with access. These privileges can clearly be altered, by a person having authority to do so (for example someone in an “administrator” role), simply by “clicking” on the relevant row and column intersection. As can be seen from the screen, there are view rights, and the creator/owner of an object can restrict the view rights of others, and can modify the rights of others with respect to a resource. Thus, even though the system may be configured to provide access to sales leads to all sales representatives, the creator of a particular sales lead may restrict the right of a particular other sales person to view that lead. This is an “override” right, and the creator of a resource may be granted this right. Other rights include the right to create dynamic rules for oneself, and the right to create dynamic rules for others. For example, FIG. 4 is a screen designated “user defaults”, which shows the rights and privileges that a current user designated “simplerm” wishes to give to another user, in this case designated “ericm” for the objects of which simplerm is the creator or owner. These privileges, granted specifically by the creator, will override those that might be given to ericm by the system administrator at an organizational level. These organizational level rights and privileges have been discussed above, with reference to FIG. 3.

As distinct from rights, the system of the invention also specifies “permissions”. Thus, for example, one can supply “hints” to the secure data access system about the level of permission required for a party to access a resource. For example, the following levels of permission can be set: allow—a clear hint to allow access to the resource; deny—a clear hint to deny access to the resource; and “don't know”—which is a mechanism that a system “arbiter” will resolve, as explained below.

In general, when a resource or business object is created, the system of the invention creates a relationship between the business object or resource and the creator. For example, as shown in FIG. 4, there are specific privileges defined for various roles in the organization. The illustrated example shows the privilege for the “owner” role, and similar screens may be obtained for other roles within the organization, such as manager, assignee, and the like. Each of the “checkboxes” illustrated can be modified to deny or allow a certain privilege, such as the right to write, delete, and read a full copy of the resource. In general, the illustrated system, which is one embodiment of the invention, is configured so that the creator is also the owner of the resource or business object, and the creator or owner have the right to assign responsibilities to an assignee. Other configurations are possible due to the flexibility of the invention. Thus, for example, if a sales manager were to acquire a sales lead, and were to create a resource regarding that lead (an “instance” within a sales leads business object), he would be the creator and owner. However, the sales manager has the right, as creator and owner, to assign responsibility for the sales lead to a sales representative. If the assignee is an individual, the assignee may have a limited right to reassign the responsibility for the resource to another, and his power of reassignation may be restricted by the system to reassigning back to the owner.

In other aspects of the creator-owner role, the system of the invention permits an assignee, which is a user or a group, to allow any member (of that group) to either (a) claim the assignment, (b) reassign it to any other member of the group, or (c) reassign it back to the owner. The owner of the object continues to retain the ownership of the object. Thus, for example, if the sales manager were to assign the sales lead to the group of sales representatives, rather than an sales person individual in particular, then any member of the sales group can claim the sales lead, reassign it to another sales representative, or reassign it back to the sales manager.

In a further example of the system according to the invention, the owner of a business object can relinquish control of the object by “transferring” it to another user or group (this also transfers “ownership”). The transferee (the user to whom the object is transferred, or the member of the group who downloads the object) now becomes the owner of the object. All access privileges of the object are now determined by the rights of the new owner. Thus, the system allows users to control the work and responsibilities of those they work with.

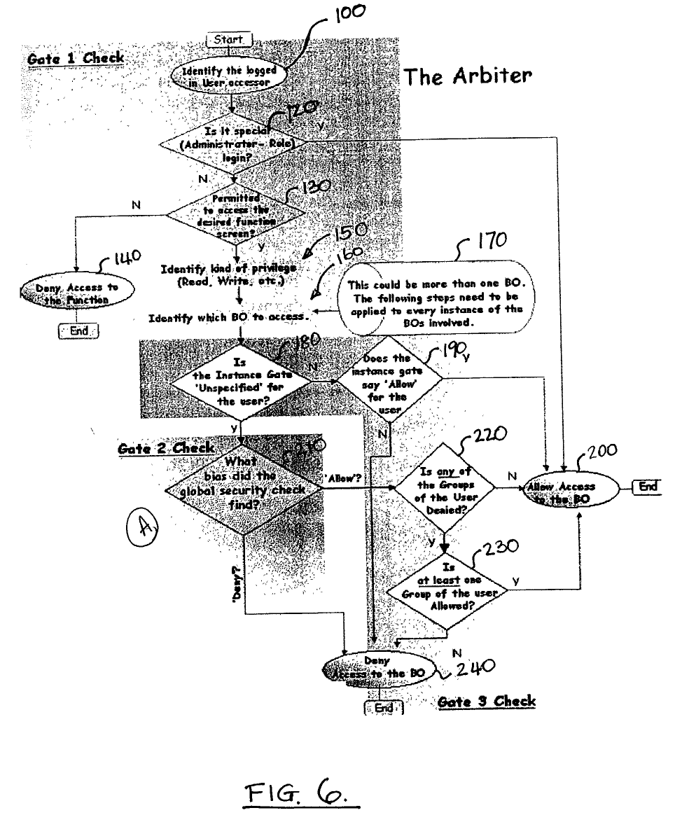

In accordance with the invention, a rules-based secure data access system is used. The system has essentially three “gates”, as shown in FIG. 6 which illustrates an example of a gated access system. Of course, other configurations may also be used within the scope of this invention. When a user logs on to the system, the system first identifies the logged in user to determine whether that person is a valid authorized accessor, 100. If the party is a valid accessor, the system then further checks whether the person has a “special” log in, in other words whether the person is in the role of an “administrator”, a role that has access to all resources of the database, 120. Once permission is obtained, and the user selects a desired screen (business function) to access, the system checks whether the accessor has a role that provides such permission, 130. If the person does not, then the system denies access to the function, and the session ends, 140. On the other hand, if the accessor has permission, then the system identifies what kind of privilege the accessor has 150; in other words, whether the accessor is allowed to read, write, modify, delete, etc., the resource being accessed. Having identified the type of right and privilege granted to the accessor, the system then identifies which business object must be accessed, 160. As noted, the request for information may require accessing more than one business object, 170. In each case several steps of security are applied to every instance of each of the business objects involved, 170. (Recall that an instance includes resources within a business object.)

The system now tracks through a “gate 3” check, and determines whether a particular instance gate is “unspecified” (i.e., does not positively say access is allowed or denied) for the user, 180. If the instance gate is not unspecified, then the system continues to check whether the instance gate says “allow” or denies the user access to the instance, 190. If in fact the gate finds that the accessor is permitted access to the instance, then access is allowed to that instance of the business object, 200. This check is completed for each and every instance of the business object, before access is permitted to the business object comprising all of the allowed instances.

On the other hand, if gate 3 had indicated that the instance of the business object was “unspecified” for the user, then a “gate 2” check is initiated. In this gate 2 check 210 the system checks what “bias” there is configured in the system to allow the accessor, based on his or her roles, access or to deny access to the instance. This process for dealing with the “unspecified” criterion will be explained in more detail below. In the event that the bias is configured in favor of allowing access, then the system flows to gate 3, where the system then checks whether any of the groups to which the user belongs may be denied access to the instance, 220. If none of the groups to which the user belongs is denied access, then the user is allowed access. On the other hand, if there is not at least one group to which the user belongs in his/her individual role that is allowed access 230, then the system denies access, 240.

The foregoing presents a straightforward and simplified example of the type of logic that may be employed with the secure data access system of the invention. Clearly, modifications and reconfigurations can readily be made to the logic system, depending upon the needs of the business organization, or other organization, that uses the system to control access to its database.

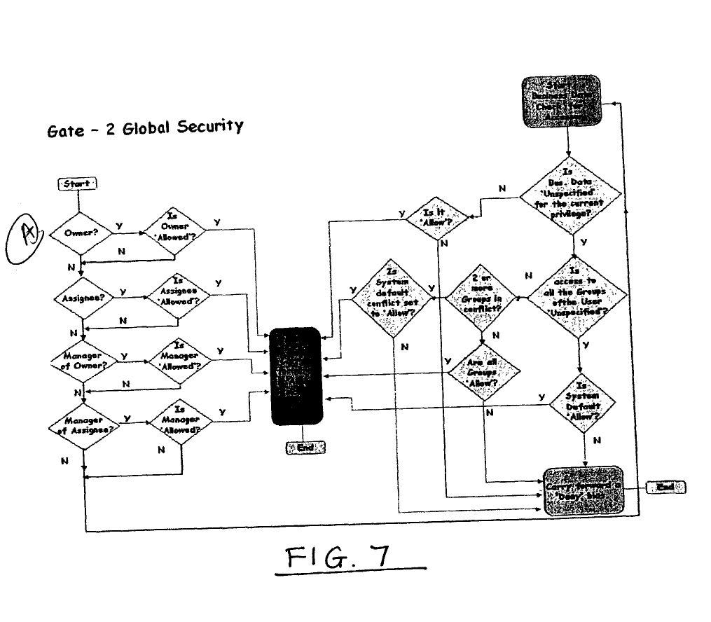

The following description of the arbiter portion of gate 2 of the security system may also be modified, but an exemplary embodiment is illustrated in FIG. 7. With reference to this figure, it can readily be seen that the system may be configured to check for access from two points of view: either based on the role of the accessor; or based on the type of resources being requested by the accessor.

Commencing with the check based on the role of the accessor, we note that the system checks whether the accessor is the owner of the resource 250, and then if owner is allowed access 255, it allows the owner access to the resource. If the accessor is not the owner, the system checks whether he or she is the assignee 260, and if he or she is the assignee 265, access is permitted. Further, if the accessor is neither owner nor assignee, the system checks whether the accessor is the manager of the owner 270. If the accessor is the manager of the owner 275, access is allowed. If the accessor is neither owner nor assignee nor manager of the owner, then the system checks whether the accessor is the manager of the assignee 280. If the accessor is the manager of the assignee 285, access is permitted. On the other hand, if the accessor is neither owner nor assignee nor manager of the owner nor manager of the assignee, then the system is configured to commence a “business data” or resource check for the accessor 300. Thus, the system determines whether the business data or resource is “unspecified” (neither listed as allowed or denied access) for the current rights and privileges of the accessor 310. If this is the case, then the system further checks whether access to all the groups to which the user belongs is “unspecified” 320. If this is the case, and access to all the groups to which the user belongs is unspecified, then this particular system configuration checks whether the system default is to allow access 330. If the system default is to allow access 340, then access is allowed. If not, then access is denied.

Returning to process 300, if the business data is not unspecified for the accessor, then the system is configured to check whether the business data or resource allows access to the accessor 350. If he is, then he is allowed access. If he is not allowed access, then access is denied.

Returning to the process 320 in which the system checks whether access to all groups to which the user belongs is “unspecified”, and if this is determined not to be the case, but some groups are permitted access while others are denied, then the system checks if two or more groups are in conflict 360. If the groups are not in conflict 370, and all are allowed access, then the user is allowed access. On the other hand, if all groups are not allowed access, then the user is denied access. But, if some groups are allowed access and others are not, then the system may be configured to use a “default” 400. This default may be set to either allow or deny access, depending upon the preferences of the organization using the secure data access system. In the illustrated example, when the default is set to allow, then the accessor is allowed access. Clearly, the default may also be set to deny access, if two or more groups are in conflict, as described.

Having described an embodiment of the security system of the invention for accessing information in the database, we now proceed to a brief discussion of an embodiment of the database query subsystem.

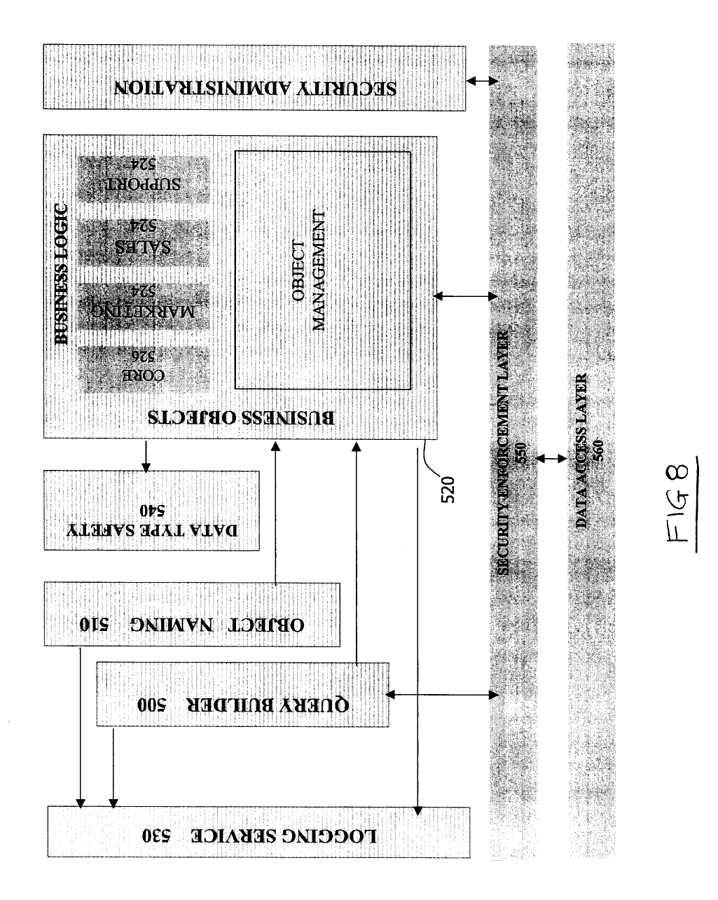

FIG. 8 is a schematic diagram, showing the interrelationship between a query builder, an object management system, a security enforcement layer using the secure data access system of this invention, and a data access layer that includes a database, of any type. In this simplified embodiment, the query builder 500 communicates with the business objects and business logic block 520, since each query could be created by naming business objects 510. As explained below, there is also an alternative route for querying the database. However, when the query builder 500 uses object naming 510, then the objects are located within the business objects/business logic organization 520, that is divided in this example into three business functions, marketing, sales and support 524. The business object management block 520 may communicate with a logging service 530 to keep track of the user seeking to access objects, the objects sought to be accessed time of access, and like audit-required details. Further, the object management block 520 communicates with a data type safety process 540, that conducts a “consistency check” to ensure that the query naming objects has used valid object names, and that the use of object names is consistent with the system structure. In order to retrieve information or resources regarding the business object being queried, the object management block 520 communications with the security enforcement layer 550. The security enforcement layer 550 includes the dynamic rules-based secure data access system that is described above, in particular with reference to FIGS. 6 and 7 that show an exemplary embodiment of the secure data access system. Once it has been established through the security system 550 that access to the objects is permitted, then communication continues through to the data access layer, that contains the desired object resources 560, for information retrieval and presentation to the accessor. This check is also carried out on an attribute and instance level to ensure that only those attributes and instances that are permitted for the accessor are shown to her and to control the degree of manipulation allowed for the particular accessor.

As explained above, a query may also be devised that does not name business objects, and that does not necessarily utilize the business objects/business logic block 520. In that case, the query is created using a language that is compatible with the database type. For example, SQL may be used with an Oracle database, and in this way the business object approach may be bypassed. This methodology offers certain advantages, in that several steps are eliminated, but it is dependent upon use of the appropriate language compatible with the database. Once again, the query is communicated to the security enforcement layer 550, and only if access is allowed, does the query extract resources from the data access layer 560 in order to response to the query. The foregoing description is one example of an embodiment of a database querying system, in accordance with the invention, and modifications may be made in order to suit various requirements of particular organizations.

As explained above, in accordance with the invention, the scalable relationship platform business objects can be queried using an object query building mechanism, in much the same way as database tables can be queried. However, the queries are configured using a programmatic object-oriented interface rather than a dedicated language interface, such as SQL. Query building (“QB”) enables business application programmers to retrieve data for use in reporting, or to build searches that encompass all business functions, and therefore all business objects and resources within the database.

There are two stages in the development of a query: the first is constructing the query; and the second is running the query.

In constructing a query, the following steps must be undertaken:

(1) The accessor must declare who participates in the query; he must specify the business objects that the query spans.

(2) The accessor must specify relationships between those participating in the query. The accessor must specify relationships between the business objects involved in the query. If the query is being used in connection with the scalable relationship platform, that is the described in more detail in our co-pending application, then the scalable relationship program maintains a static map of relationships between business objects that might be used. Alternatively, the accessor may relate the objects using other attributes.

(3) The accessor must specify conditions comparing those partaking in the relationships with immediate but in constant expressions. In other words, the accessor may specify any conditions the attributes of the business objects must meet for the result to be returned.

(4) The accessor must specify what should be returned by the query when it is run. In other words, the accessor can specify which attributes of the business objects or whether all of the attributes of the business objects should be returned. The accessor can also request any number of business objects or attributes of these, but may either ask only for business objects, or only for attributes of any business objects.

(5) The accessor must specify the format in which the resources should be returned. The accessor may specify the order of sorting based upon values of one or more attributes, whether ascending or descending, he may also specify the results based upon certain criteria, and whether only distinct results should be returned. The accessor may also limit the number of records that should be returned. Further and other limitations may also be configured into the system, as required by the business organization.

Once the query has been constructed, it is ready to run. Once it is run, it will return a result in the form of records of business objects, attributes of these business records, or records, as specified in the query construction phase.

In a particular embodiment, an IQuery (or “q”) interface enables the building of queries. The accessor can specify that entire business objects be retrieved when the query is run. In order to do this, the user calls IQuery.addBOScope( ) for each business object that he wishes to retrieve.

The user may specify that entire business objects be retrieved when the query is run. To do this, IQuery.addBOScope( ) is called for each business object that must be retrieved. For example, one may wish to review all sales made by an organization. Here, if the user wants to obtain all the details of the sales, he/she calls : q.addBOScope(SaleBO).

The user can also specify that attributes of business objects be retrieved. These attributes may span several business objects, and to do this the user uses IQuery.addAttribScope( ). For example, one may wish to review all sales made by an organization, in the context of only the revenue earned in each sale, and the date of sale. Here, one wishes to obtain only some of the details of each sale. Thus, the user would call q.addAttribScope(SaleBO.REVENUE, SaleBO.BODATECREATED).

The accessor can also supply conditions to permit retrieving only those results that match the specified conditions. For example, the user can combine conditions with existing conditions using logical operators. Such conditions are known as “simple conditions”. For example, the accessor may wish to review, all sales that generated more than $2,000 of revenue. For this, the accessor can select addCondition( ) “SalesValue, LogicalOperator.GT.2000”.

But, the user may want to review only all sales made last month that fetched over $2,000 for each sale. He/she would then call:

q.addCondition( ) “(SalesValue, LogicalOper.GT, 2000 )

LogicalOper.AND (BODateCreated, LogicalOper.LT, Today)

LogicalOper.AND, (BODateCreated, LogicalOper.GT, Today—30 days)”

Sometimes it is not possible to formulate a condition by combining with any existing conditions. In these cases, the system is configured to allow the initial building of conditions outside, and then to apply them to IQuery. Compound conditions allow building arbitrary combinations of simple conditions or other compound conditions. Condition clauses and join clauses may co-exist. For example, you want to review sales that fetched over $2,000 each last month or all sales that fetched over $5000 each last quarter. You would then call:

q.addCompositeCondition( )

“(SalesValue, LogicalOper.GT, 2000)

LogicalOper.AND, (BODateCreated, LogicalOper.LT, Today)

LogicalOper.AND, (BODateCreated , LogicalOper.GT, Today—30 days)

q.add(CompositeCondition( )

LogicalOper.OR, (SalesValue, LogicalOper.GT, 5000)

LogicalOper.AND, (BODateCreated, LogicalOper.LT, Today)

LogicalOper.AND, (BODateCreated , LogicalOper.GT, Today—90 days)”

As pointed out above, the scalable relationship platform maintains a map of the relationships between business objects. These can be used as filters on the results, by building “joins” on referrer URL attributes. One can also build joins on other attributes. One can combine new joins of any existing join clauses using suitable logical operators. For example, if one wants to get all sales made to customers in your Eastern sales zone, one then calls:

q.addBOScope(SaleBO)

q.addJoinScope( ) “AccountBO.ACCOUNTID, Joinoperator.EQUALS,

SaleBO.ACCOUNTID”

q.addCondition( ) “AccountBO.REGION, EQUALS, ‘EAST’

The query system is also configured to apply transformation functions on attributes of business objects. One can specify that the query return the transformed results. Some transformation functions aggregate the sets of results so that a summary can be obtained. For example, one can concatenate the first name and the last name of a contract into the result using the CONCAT method in SRMTransformFn. One can, for example, also determine the total sales for a given product category in a month, using the SUM method. One then calls:

Totalrevenue=SRMTransformFn.SUM(REVENUE)

q.addAttribScope(Totalrevenue)

q.addCondition( ) BODATECREATED, GT, Today

q.addCondition( ) AND, BODATECREATED, GT, Today—30 days

When results are gathered using aggregate transformation functions, it is sometimes necessary to group them in a way that summarizes similar results together, and this can be achieved using the SUM method. For example, you wish to determine the total sales made to each customer last month. That is, you want to retrieve separate sales figures for each customer by running a single query. Then you use the SUM method in SRMTransformFn, as before, but you also group the results by customer name. This will result in separate summarized results for each customer.

Totalrevenue=srmTransformFn.SUM(REVENUE)

q.addAttribScope(Totalrevenue)

q.addAttribScope(ACCOUNTNAME)

q.addJoinScope( ) AccountBO.ACCOUNTID, EQUALS, SaleBO.ACCOUNTID

q.addGroupByAttribute( ) ACCOUNTID

q.addCondition( ) BODATECREATED, GT, Today

q.addCondition( ) AND, BODATECREATED, GT, Today—30 days

IQuery allows sorting of results by choosing one or more attributes as axes along which conducts sorting. As indicated before, the order of sorting may be ascending or descending.

Sometimes it is necessary to distinguish between multiple occurrences of a given business object within the same query. To make this possible, business objects may be bound to named query sub-spaces. Each occurrence of the business object can only exist within one sub-space, and each sub-space can accommodate only one business object. Thus, using sub-spaces isolates the occurrences of the same business objects from each other. While business objects can span several sub-spaces, each occurrence exists within a single sub-space. To bind a business object to a named query sub-space, one must bind each attribute of it that partakes in the query. Note that a business object can span several sub-spaces, each occurrence lives within a single sub-space. To bind a business object to a named query sub-space, you bind each attribute of it that partakes in the query. One can do this by calling SRMStdAttributelnfo.bindToNS( ) or SRMURLAttributelnfo.bindToNS( ).

When a query is run, the accessor can specify which records to retrieve. If the accessor is retrieving business objects, she can indicate whether they must be completely filled about return, or whether only the outermost attributes must be filled. One would typically use this option to improve performance. Before running the query, one would also have to specify the business context in which to run the query. The business context bc represents the user who is running the query. After the query runs, results are returned back up to the extent the user represented by bc is permitted to read objects. Thus, any data the user wants to retrieve runs through the same security checks as discussed above. If a record retrieved spans several business objects, then it is shown to the user only if he is authorized by the security gate system to read every instance of each business object returned in that record. A record is also shown if a business object involved does not permit a “full read” but permits a “limited read” to the user, where all attributes requested have been configured into the set secured by the “limited read”. Any record that does not meet these constraints is removed from the set of results. For instance, after having formulated a query, you can retrieve query results by calling:

SRMQueryResult qr=qb.runQuery (bc, true, −1).

When the query is run, a “query result” is returned. It represents the set of results called the “record-set” and auxiliary information called “meta-data” describing the results. There are as many entries in the “record-set” as the number of matching entries in the database. The match is made by applying join clauses, grouping clauses or conditional clauses that had been specified when the query was being constructed. For instance, after the query result is obtained, you may wish to loop through the result until you have “consumed” them all:

q.addAttribScope(REVENUE)

q.addAttribScope(BODATECREATED)

q.addCondition( ) (REVENUE, LogicalOper.GT, 2000),

SRMQueryResult qr=qb.runQuery (bc, true, −1)

SRMRecordSet rs=qr.getRecordSet( )

While(rs.hasNext( ) ){

List t=rs.getNext( )

Revenue=t.get(0)

Print(Revenue)

DateSold=t.get(1)

Print (DateSold)

You can use meta-data resulting out of running a query to cross-refer elements in a record (of a record-set) to corresponding attributes or business objects. You can determine the data type of each element in the record, so this is useful to generic query viewers to represent an element in the correct form.

The foregoing has described certain embodiments of a dynamic rules-based secure data access system that may be used in conjunction with any database, or multiple databases, and in particular with databases associated with relationship platforms. The dynamic rules-based secure access system is based on the assignment of roles to individuals and to groups, and the structuring of information into a hierarchy, so that access can be allowed or denied to any level of the hierarchy, and further so that when access is allowed to a certain hierarchy level, access might be restricted on that level so that only certain resources (attributes) may be viewed, and so that the manipulation of these resources may also be further restricted based on assigned accessor rights. Further, the foregoing has provided a unique language and methodology for creating queries and accessing the database through the dynamic rules-based secure data access system. The query language is highly flexible, and relates directly to hierarchical structure, thereby facilitating ease of data access. In an alternative, the database may be queried through the use of any standard query language that is compatible with the database, while preserving data security through use of the dynamic rules-based secure data access system of the invention. The invention provides features that distinguish over other systems that seek to achieve the same or similar ends, and provides a more flexible security system.

It will be obvious to those having skill in the art that many changes may be made to the details of the above-described embodiments of this invention without departing from the underlying principles thereof. The scope of the present invention should, therefore, be determined only by the following claims.

1. A security system for permitting or denying access to a database comprising resources, the system comprising:
organizing the resources into at least two identified business functions to which access is controlled;
organizing resources within each business function into a hierarchical arrangement comprising levels at which access can be controlled to any accessor;
assigning at least one role to each accessor, the role determining the level of the hierarchical arrangement at which the accessor is allowed to access resources; and
defining the rights and privileges of an accessor to accessed resources based on a role of the accessor.

2. The system of claim 1, wherein the database is in communication with a messaging platform.

3. The system of claim 1, wherein the organizing into a hierarchical arrangement comprises organizing into at least two levels of hierarchy.

4. The system of claim 3, wherein the organizing identified business functions comprises organizing resources into sales, marketing and customer relations functions.

5. The system of claim 3, wherein at least one screen displays resources of each identified business function, to an accessor who is granted access.

6. The system of claim 3, wherein each identified business function comprises business objects, the business objects comprising resources about their respective business functions.

7. The system of claim 6, wherein each business object is displayed on a screen, when access is granted to that business object.

8. The system of claim 6, wherein each business object comprises instances of the business object, the instances each comprising resources about a specific item within their respective business objects.

9. The system of claim 8, wherein individual instances are displayed on a screen, when access is granted to an accessor.

10. The system of claim 1, wherein the assigning of roles comprise assigning of at least three separate roles, each separate role corresponding to access to a different level in the hierarchical arrangement.

11. The system of claim 1, wherein at least one of the roles comprise groups of individual accessors.

12. The system of claim 1, further comprising identifying an accessor, and identifying the role of the accessor.

13. The system of claim 1, wherein defining the rights and privileges of an accessor comprises defining the accessor's permission to read, write, create, and delete information on a level of the resource to which access is permitted.

14. The system of claim 1, wherein the defining of rights and privileges is carried out by a creator of a resource.

15. The system of claim 14, wherein the creator of the resource controls the rights and privileges based on accessor role.

16. The system of claim 14, wherein the creator assigns rights and privileges to a designated assignee.

17. The system of claim 16, wherein the assignee further delegates at most the rights and privileges assigned to it to a second level assignee.

18. The system of claim 1, wherein an accessor has rights and privileges to interact with resources comprising at least one of the following activities : to create resources, to view a portion of a resource content, to view all of a resource content, to modify a resource, to delete a resource, to view rights and privileges of other, to modify rights and privileges of others, to modify rights and privileges of the accessor.

19. A system comprising a secure data access protocol for controlling access to a database, the database comprising a hierarchy of information, and the access protocol comprising:
decision criteria for allowing or denying access to the database, the criteria using roles assigned to potential accessors of the database to determine access to any one or more levels of hierarchy of the database; and
rules defining rights and privileges of accessors of the one or more levels, the rules and privileges defining limits to viewing of accessed resources and defining limits to manipulation of the resources.

20. The system of claim 19, wherein the hierarchy of the database comprises a first level wherein the resources are identified with two or more functional modules.

21. The system of claim 20, wherein the functional modules comprise business objects.

22. The system of claim, 21, wherein each business object comprises instances of the business object.

23. The system of claim 22, wherein the business objects and the instances comprise attributes.

24. The System of claim 23, wherein the decision criteria determines user access at least at the function, business object and instance level.

25. The system of claim 24, wherein the access is limited to at least any one or more of the following activities by rules and privileges of the user: full read, limited read, write, modify and delete.

26. The system of claim 24, wherein the decision criteria comprises a sequence of steps to check whether access to resources is permitted to the user, at least one of these steps comprising determining access to the functional module to which access is sought, based on a role of the user.

27. The system of claim 26, wherein the decision criteria further comprises determining, after a determination that the user has access to the functional module, what the rights and privileges of the user are with respect to the resources sought to be accessed.

28. The system of claim 27, wherein the decision criteria permits user access to the functional module if access is permitted by user role, and sets limits on user access based on user rights and privileges.

29. The system of claim 28, wherein the system identifies which business objects must be accessed to provide the user with resources sought to be accessed.

30. The system of claim 28, wherein the decision criteria determine, for each instance of a business object sought to be accessed, whether the user is permitted access to the each instance.

31. The system of claim 30, wherein the decision criteria selectively allows user access to an instance of a business object if permission based on the user's role is unspecified, but the user is a member of at least one group role that is allowed access to the instance.

32. The system of claim 30, wherein the decision criteria are set to allow user access to an instance of a business object if permission based on the user's role is unspecified, and the user is a member of at least one group role that is denied access to the instance.

33. The system of claim 30, wherein the decision criteria are set to deny user access to an instance of a business object if permission based on the user's role is unspecified, and the user is a member of at least one group role that is denied access to the instance.

34. The system of claim 30, wherein the decision criteria comprises the following steps to determine access, when the access to an instance is unspecified for the user's role
check whether system bias allows access when role based access is not specified for the user's role, if so allow access, if not, then determine if any group role of which the user is a member is denied access, if not allow access, but otherwise check whether at least one group role of which user is a member is allowed access, if so then allow access.

35. The system of claim 34, wherein the decision criteria further comprise determining whether the instance sought to accessed is consistent with rights and privileges of the user.

36. The system of claim 30, wherein the decision criteria further comprise determining whether the instance sought to accessed is consistent with rights and privileges of the user.

37. The system of claim 20, wherein the decision criteria further comprise determining whether the instance sought to accessed is consistent with rights and privileges of the user.

38. The system of claim 19, further comprising a query builder functionality, the query builder comprising a query language for accessing resources from the database, queries using the query language comprising a business object sought to be accessed.

39. The system of claim 38, wherein the decision criteria operate on the user's role, any group role of the user, the named business object, and the user's rights and privileges to determine the user's access rights to the business object.

40. The system of claim 39, wherein the decision criteria operate on the user's role, any group role of the user, the user's rights and privileges and each instance of which the sought business object is comprised, and the user's rights and privileges to determine the user's access rights to the instances.
